(19) United States
(12) Patent Application Publication
(10) Pub. No.: US 2013/0122773 A1
(43) Pub. Date: May 16, 2013

(54) Nonwoven Materials from Polymer Melt Filaments and Apparatuses and Methods Thereof

(71) Applicants: Sanjay Wahal, Appleton, WI (US); Edward J. Clark, Pearisburg, VA (US); Randall Skattum, Dallas, TX (US); Jeffrey Scott Conley, Narrows, VA (US)

(72) Inventors: Sanjay Wahal, Appleton, WI (US); Edward J. Clark, Pearisburg, VA (US); Randall Skattum, Dallas, TX (US); Jeffrey Scott Conley, Narrows, VA (US)

(21) Appl. No.: 13/297,716

(22) Filed: Nov. 16, 2011

(51) Int. Cl. D04H 3/005; D04H 3/11; B29C 47/08; D04H 3/03; D04H 3/105; B82Y 30/00

(52) U.S. Cl. 442/400; 442/402; 442/408; 425/72.2; 264/210.8; 977/742

(57) ABSTRACT

Systems for producing bulked webs and/or nonwoven materials may include at least one extruder having a plurality of nozzles and a master air jet in communication with at least one extruder to receive a plurality of polymer melt filaments from at least one extruder to form a bulked web. Producing bulked webs may include at least the steps of forming a plurality of polymer melt filaments; passing the plurality of polymer melt filaments through a master air jet thereby forming a bulked web; and collecting the bulked web.

### BACKGROUND

The present invention relates to nonwoven materials produced from polymer melt filaments, and to apparatuses, systems, and methods related thereto.

Nonwoven fabric is a term of art that refers to a manufactured sheet, batting, webbing, or fabric that is held together by various methods. Those methods include, for example, fusion of fibers (e.g., thermal, ultrasonic, pressure, and the like), bonding of fibers (e.g., resins, solvents, adhesives, and the like), and mechanical entangling (e.g., needle-punching, hydroentangling, and the like). The term is sometimes used broadly to cover other structures such as those held together by interlacing of yarns (stitch bonding) or those made from perforated or porous films. The term excludes woven, knitted, and tufted structures, paper, and felts made by wet milling processes.

Nonwoven materials can be produced from carding processes that convert bales of staple fibers into mats that are needlepunched or hydroentangled to produce the nonwoven materials. Staple fibers are short fibers (approximately a few centimeters in length) that during carding are spread into a uniform web. The processing of the staple fibers often causes some of the staple fibers and pieces thereof to become airborne. These airborne fibers may collect in the equipment leading to increased maintenance and possible downtime. Further, airborne fibers pose inhalation and dermal irritation risks to workers.

Because of the significant investment in capital equipment for carding and health issues associated with processing bales of staple fiber, the production of nonwoven materials from polymer melt filaments has been of interest to one skilled in the art. As used herein, the term “polymer melt filaments,” and derivatives thereof, refers to the filaments produced from a polymer melt, which may include, but not be limited to, spunbond filaments, meltblown filaments, and electrospun filaments.

Most commonly, nonwoven materials that include thermoplastic filaments are produced from a polymer melt. Nonwoven materials from polymer melt filaments are generally produced by extruding the filaments from a polymer melt, attenuating the filaments to a desired filament diameter, collecting the filaments on a conveyor to form a web, and optionally further bonding the web by needle punching, hydroentangling, adhesively bonding, or thermal bonding. Traditionally, nonwoven materials and products produced from polymer melt filaments have a low caliper. As used herein, the term “caliper” refers to thickness. Therefore, nonwoven materials produced from polymer melt filaments have a limited use in areas such as surgical drapes, disposable diapers, and wipes. Applications that use higher caliper nonwovens, e.g., insulation, filtration, sorbents, and some textiles, are limited to nonwovens produced from carding processes as well as air laid processes.

Typically, caliper is increased by, for example, laying of the filaments on a moving conveyor traveling slower than the filaments are produced, which allows for the filaments to pile to thereby increase caliper in the web. This process of increasing caliper has limitations including, but not limited to, increases in caliper increase the weight of the web and too high of a caliper can reduce the interfiber bonding, each of which have ramifications of increased weight and/or decreased strength in the final nonwoven material. Further, the subsequent steps to enhance interfiber bonding of the web to form the nonwoven material usually reduce the caliper, thereby yielding a nonwoven material with a relatively low caliper.

Apparatuses and methods that may be used to increase the caliper and decreasing the density of webs of polymer melt filaments, thereby increasing the caliper and decreasing the density of the resultant nonwoven materials produced therefrom, would be of benefit to one skilled in the art.

### SUMMARY OF THE INVENTION

The present invention relates to nonwoven materials produced from polymer melt filaments, and to apparatuses, systems, and methods related thereto.

In some embodiments, the present invention provides a system that comprises at least one extruder having a plurality of nozzles; and a master air jet in communication with at least one extruder to receive a plurality of polymer melt filaments from at least one extruder to form a bulked web.

In some embodiments, the present invention provides a system that comprises at least two extruders having a plurality of nozzles; an attenuator in communication with a first extruder to receive a first plurality of polymer melt filaments from the first extruder to form a plurality of attenuated filaments; a master air jet in communication with a second extruder and the attenuator to receive a second plurality of filaments from the second extruder and the plurality of attenuated filaments to form a bulked web.

In some embodiments, the present invention provides a method that comprises forming a plurality of polymer melt filaments; passing the plurality of polymer melt filaments through a master air jet thereby forming a bulked web; and collecting the bulked web.

In some embodiments, the present invention provides a method that comprises forming a plurality of first polymer melt filaments; forming a plurality of second polymer melt filaments; and introducing the plurality of first polymer melt filaments and second polymer filaments into a master air jet thereby forming a bulked web.

In some embodiments, the present invention provides a method that comprises forming a plurality of polymer melt filaments; introducing the plurality of polymer melt filaments into a master air jet thereby producing a bulked web; and forming a nonwoven material from the bulked web.

The features and advantages of the present invention will be readily apparent to those skilled in the art upon a reading of the description of the preferred embodiments that follows.

### BRIEF DESCRIPTION OF THE DRAWINGS

The following figures are included to illustrate certain aspects of the present invention, and should not be viewed as exclusive embodiments. The subject matter disclosed is capable of considerable modifications, alterations, combinations, and equivalents in form and function, as will occur to those skilled in the art and having the benefit of this disclosure.

FIG. 1 illustrates a front view and a side view of a nonlimiting example of a system according to the present invention for producing bulked webs having polymer melt filaments.

FIG. 2 illustrates a nonlimiting example of a system schematic according to the present invention for producing bulked webs having polymer melt filaments.

FIGS. 3A-D illustrate side views of nonlimiting examples of systems according to the present invention for producing bulked webs having polymer melt filaments.

FIG. 4 illustrates a perspective view of a nonlimiting example of a master air jet for use in conjunction with the systems of the present invention.

FIG. 5 illustrates a side view, partially in section, of a nonlimiting example of a master air jet for use in conjunction with the systems of the present invention.

FIG. 6 illustrates a plane view of the housing of a nonlimiting example of a master air jet for use in conjunction with the systems of the present invention.

FIG. 7 illustrates an end view illustrating the outlet opening in the housing of a nonlimiting example of a master air jet for use in conjunction with the systems of the present invention.

FIG. 8 illustrates a view of one of the side plates of the housing of a nonlimiting example of a master air jet for use in conjunction with the systems of the present invention.

FIG. 9 illustrates an end view of the inlet opening of the housing of a nonlimiting example of a master air jet for use in conjunction with the systems of the present invention.

FIG. 10 illustrates a perspective view of a nonlimiting example of a master air jet of the present invention for use in conjunction with the systems of the present invention.

FIG. 11 illustrates a view of one of the side plates of the housing of a nonlimiting example of a master air jet of the present invention for use in conjunction with the systems of the present invention.

FIG. 12 illustrates a perspective view of a nonlimiting example of a master air jet of the present invention for use in conjunction with the systems of the present invention.

### DETAILED DESCRIPTION

The present invention relates to nonwoven materials produced from polymer melt filaments, and to apparatuses, systems, and methods related thereto.

The systems described herein enable the production of high caliper nonwoven materials that include polymer melt filaments. In some embodiments, the systems of the present invention may be capable of producing bulked webs of polymer melt filaments that may be further processed to produce nonwoven materials with high caliper. The systems and methods of the present invention may advantageously be integrated with other processes and equipment for downstream nonwoven processing (e.g., hydroentanglement, thermal bonding, etc.). Further advantageously, the systems can be configured to produce nonwoven materials with layered or complex compositions at the point of integration of the mat, which is achieved in carding and traditional nonwoven manufacturing processes by combining nonwoven materials as opposed to during actual production of the nonwoven materials.

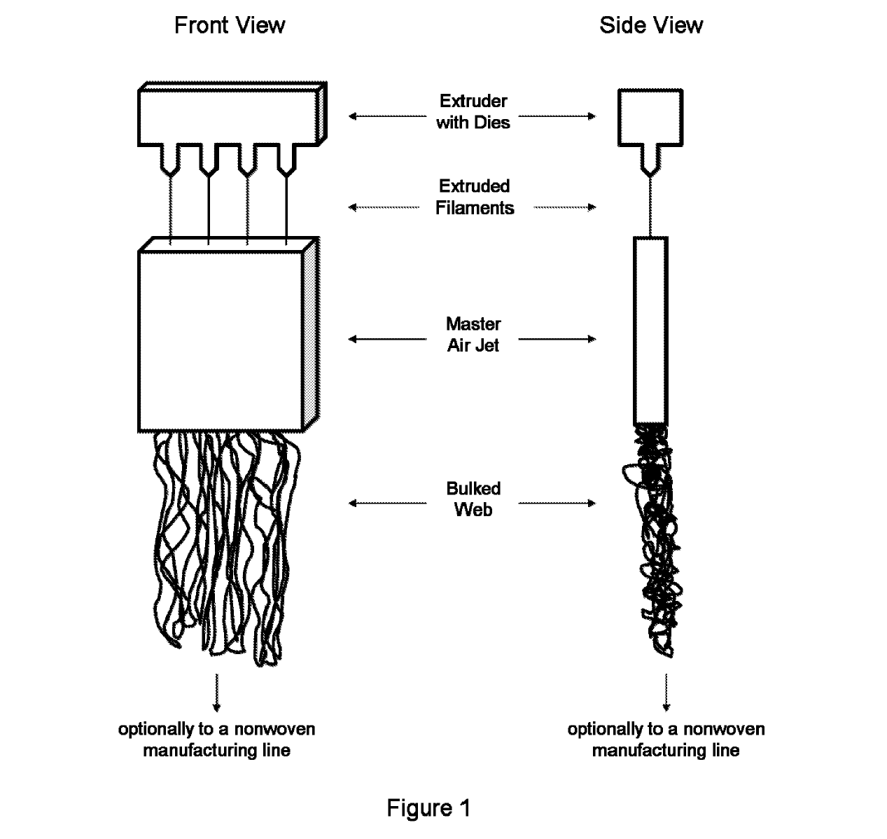

In some embodiments, the systems of the present invention for producing bulked webs of polymer melt filaments may comprise at least one extruder having a plurality of dies capable of producing polymer melt filaments and at least one master air jet in communication with the extruder to accept the polymer melt filaments to form a bulked web, a nonlimiting example of which is illustrated in FIG. 1 and detailed further below. In some embodiments of systems of the present invention having two or more extruders, said extruders may be in any relational configuration to each other. By way of nonlimiting example, four extruders having 2.5 meter (m) widths may be relationally configured side by side as 1×4 to provide polymer melt filaments to a 10 m wide master air jet. By way of another nonlimiting example, four extruders having 2.5 m widths may be relationally configured as 2×2 to provide polymer melt filaments to a 5 m wide master air jet.

Master air jets (detailed further below) generally use an air jet to create fluid flow with a Venturi effect (the reduction in fluid pressure that results when a fluid flows through a constricted section of pipe). The Venturi effect moves filaments (or webs) through the master air jet apparatus and acts to entangle filaments to form bulked webs. It should be noted that master air jets do not substantially attenuate the diameter of the filaments passing therethrough.

Some embodiments may involve producing bulked webs from polymer melt filaments. Suitable polymer melt compositions are described further herein. In some embodiments, producing bulked webs of the present invention may comprise extruding a plurality of polymer melt filaments and passing the plurality of polymer melt filaments through a master air jet of the present invention thereby forming a bulked web. As used herein, the term “bulking,” and derivatives thereof, refers to increasing caliper without substantial spreading laterally. As used herein, the term “caliper” refers to thickness. As used herein, the term “bulked web” refers to the product of entangled polymer melt filaments from the master air jet.

It should be noted that the term “polymer melt filaments” is used generally herein to describe filaments that originated from a polymer melt whether the filaments have been further processed or not. Additional terms like “extruded filaments,” “electrospun filaments,” and “attenuated filaments” (described in more detail herein) refer to polymer melt filaments after being extruded, electrospun, or attenuated, respectively. It should be noted that these terms describe only the most recent processing the polymer melt filaments have undergone and do not imply the absence or inclusion of additional processing either before or after the process to which the term refers. By way of nonlimiting example, in some embodiments of the present invention, extruded filaments may be passed through an attenuator to produce attenuated filaments.

Referring to an embodiment illustrated in FIG. 1, a nonlimiting example of a system showing a front view and a side view, in some embodiments a system of the present invention may include at least one extruder having a plurality of dies capable of producing polymer melt filaments and at least one master air jet of the present invention in communication with the extruder to receive the polymer melt filaments to form a bulked web. In the nonlimiting embodiment shown in FIG. 1, the polymer melt filaments are shown as extruded filaments as there is no additional processing apparatuses or steps before introduction into the master air jet of the present invention.

It should be noted that when “about” is provided below in reference to a number in a numerical list, the term “about” modifies each number of the numerical list. It should be noted that in some numerical listings of ranges, some lower limits listed may be greater than some upper limits listed. One skilled in the art will recognize that the selected subset will require the selection of an upper limit in excess of the selected lower limit.

In some embodiments, formation of a bulked web of the present invention may be performed with polymer melt filaments at an elevated temperature. Some embodiments may involve passing polymer melt filaments through master air jets of the present invention at or above the softening temperature of the polymer melt filament composition. As used herein, the term “softening temperature,” and derivatives thereof, refers to the temperature above which a material becomes pliable, which is typically below the melting point of the material. In some embodiments of the present invention, polymer melt filament composition may have a softening temperature ranging from a lower limit of about 50° C., 75° C., 100° C., or about 150° C. to an upper limit of about 400° C., 350° C., 300° C., 250° C., or 200° C., and wherein the softening temperature may range from any lower limit to any upper limit and encompass any subset therebetween.

In some embodiments of the present invention, it may be advantageous to entangle the polymer melt filaments at or above the softening temperature so as to mechanically bond the polymer melt filaments at a plurality of contact points. As used herein, the terms “mechanical bond,” “mechanically bonded,” “physical bond,” and the like refer to a physical connection that holds two filaments together. Mechanical bonds may be rigid or flexible depending on the bonding material. Mechanical bonding may or may not involve chemical bonding.

In some embodiments, a plurality of polymer melt filaments may be entangled and mechanically bound to form a bulked web of the present invention. In some embodiments of the present invention, mechanical bonding may occur at temperatures ranging from a lower limit of about 50° C., 75° C., 100° C., or about 150° C. to an upper limit of about 400° C., 350° C., 300° C., 250° C., or 200° C., and wherein the temperatures may range from any lower limit to any upper limit and encompass any subset therebetween.

One skilled in the art would understand the temperature ranges needed to produce bulked webs with some degree of mechanically bonding from polymer melt filaments depends on, inter alia, the composition of the polymer melt filaments including the molecular weight of the polymer(s) and the composition and concentration of the additive(s); the diameter of the polymer melt filaments; the desired packing density of the polymer melt filaments in the bulked web; and the desired degree of mechanical bonding in the bulked web.

In some embodiments, suitable polymer melt filaments for use in conjunction with the present invention may comprise thermoplastic polymers. Suitable polymers for use in producing polymer melt fibers may include, but not be limited to, ultrahigh molecular weight polyethylenes, very high molecular weight polyethylenes, high molecular weight polyethylenes, polyolefins, polyesters, polyamides, nylons, polyacrylics, polystyrenes, polyvinyls, polytetrafluoroethylenes, polyether ether ketones, non-fibrous plasticized celluloses, polyethylenes, polypropylenes, polybutylenes, polymethylpentenes, low-density polyethylenes, linear low-density polyethylenes, high-density polyethylenes, polyethylene terephthalates, polybutylene terephthalates, polycyclohexylene dimethylene terephthalates, polytrimethylene terephthalates, polymethyl methacrylates, polystyrenes, acrylonitrile-butadiene-styrenes, styrene-acrylonitriles, styrene-butadienes, styrene-maleic anhydrides, ethylene vinyl acetates, ethylene vinyl alcohols, polyvinyl chlorides, cellulose acetates, cellulose acetate butyrates, plasticized cellulosics, cellulose propionates, ethyl celluloses, any derivative thereof, any blend polymer thereof, any copolymer thereof, or any combination thereof.

In some embodiments, suitable polymer melt filaments for use in conjunction with the present invention may be bicomponent fibers. Suitable configurations for bicomponent fibers may include, but not be limited to, side-by-side, sheath-core, segmented-pie, islands-in-the-sea, tipped, segmented-ribbon, or any hybrid thereof.

Suitable polymer melt filaments for use in conjunction with the present invention may have any cross-sectional shape including, but not limited to, circular, substantially circular, crenulated, ovular, substantially ovular, ribboned, polygonal, substantially polygonal, dog-bone, “Y,” “X,” “K,” “C,” multi-lobe, and any hybrid thereof. As used herein, the term “multi-lobe” refers to a cross-sectional shape having a point (not necessarily in the center of the cross-section) from which at least two lobes extend (not necessarily evenly spaced or evenly sized).

Suitable polymer melt filaments for use in conjunction with the present invention may have a diameter ranging from a lower limit of about 0.25 microns, 0.5 microns, 1 micron, 10 microns, 15 microns, 25 microns, or 50 microns to an upper limit of about 100 microns, 50 microns, 25 microns, 15 microns, or 1 micron, and wherein the diameter may range from any lower limit to any upper limit and encompass any subset therebetween. It should be noted that for fibers of different cross-sectional shapes, one skilled in art should understand the equivalent to diameter. By way of nonlimiting example, a polymer melt filament having a Y-shaped cross-section has a diameter as defined by the substantially circular shape derived from the points of the Y-shape. One skilled in the arts should understand the extruding parameters and other apparatuses that achieve a desired diameter and cross-sectional shape. By way of nonlimiting example, extruding polymer melt filaments may include no additional apparatuses to achieve larger diameters, include an attenuator (as in melt blown processes) to achieve intermediate diameters, and include a voltage across a filament collector screen and the dies to achieve smaller diameters.

In some embodiments, additives suitable for use in conjunction with the present invention may be included in the polymer melt, applied to filament surfaces, or any combination thereof. Suitable additives for use in conjunction with the present invention may include, but not be limited to, active particles, active compounds, chelating agents, ion exchange resins, superabsorbent polymers, zeolites, nanoparticles, ceramic particles, abrasive particulates, absorbent particulates, softening agents, plasticizers, pigments, dyes, flavorants, aromas, controlled-release vesicles, binders, adhesives, tackifiers, surface modification agents, lubricating agents, emulsifiers, vitamins, peroxides, biocides, antifungals, antimicrobials, deodorizers, antistatic agents, flame retardants, antifoaming agents, degradation agents, conductivity modifying agents, stabilizing agents, or any combination thereof. Said additives are detailed further herein. By way of nonlimiting example, nanoparticles may be included in the polymer melt from which polymer melt filaments are produced. Said nanoparticles may be silver nanoparticles that impart antibacterial properties in nonwoven materials, e.g., surgical masks, produced from bulked webs of the present invention that comprise said polymer melt filaments having silver nanoparticles incorporated therein. By way of another nonlimiting example, deodorizers may be applied to bulked webs of the present invention such that nonwoven materials produced therefrom, e.g., diaper covers, have deodorant capabilities.

In some embodiments, producing bulked webs of the present invention may comprise extruding a plurality of polymer melt filaments and passing the plurality of polymer melt filaments through a master air jet thereby forming a bulked web. Master air jets generally use an air jet to create a Venturi that moves polymer melt filaments through the master air jet apparatus. The Venturi may further act to entangle polymer melt filaments as they pass through the master air jet. In some embodiments, the master air jet of the present invention may be configured to receive a plurality polymer melt filaments from at least one extruder having a plurality of dies. In some embodiments, the master air jet of the present invention may be configured to produce bulked webs from polymer melt filaments where the bulked webs have calipers and/or complex cross-sectional make-ups not previously realized. In some embodiments, the increased caliper and/or possibility of complex cross-sectional make-ups of the bulked webs of the present invention may enable the production of nonwoven materials not previous realized when produced from polymer melt filaments.

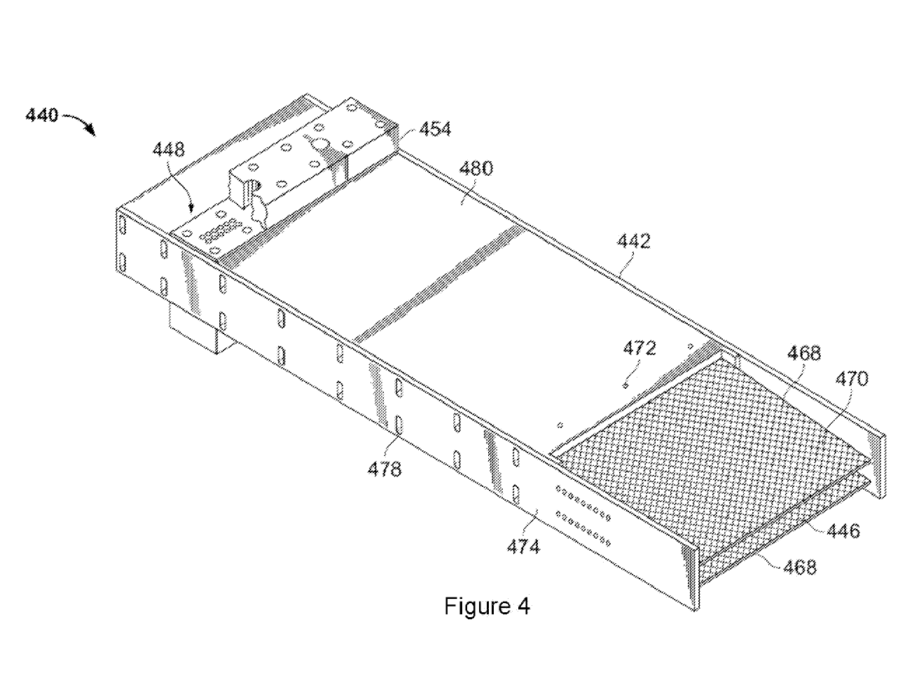

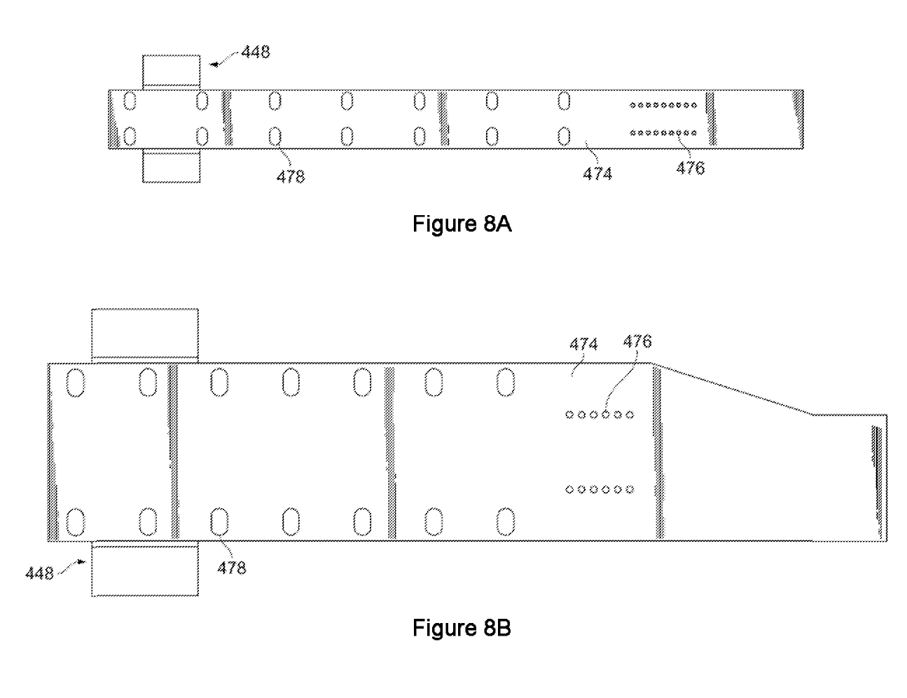

Referring now to FIGS. 4-9, nonlimiting examples of master air jets of the present invention and components thereof, master air jet 440 may include housing 442 that generally is formed by a pair of side plates 474, top plate 480, and bottom plate 482. It should be noted that side, top, and bottom to modify the plates are used for simplicity in describing the master air jet and should not be taken to be limiting as to the relation of the master air jet to the plane of the ground. The pair of side plates 474 may be operably attached to the top plate 480 and bottom plate 482 with bolts at sizing guides 478.

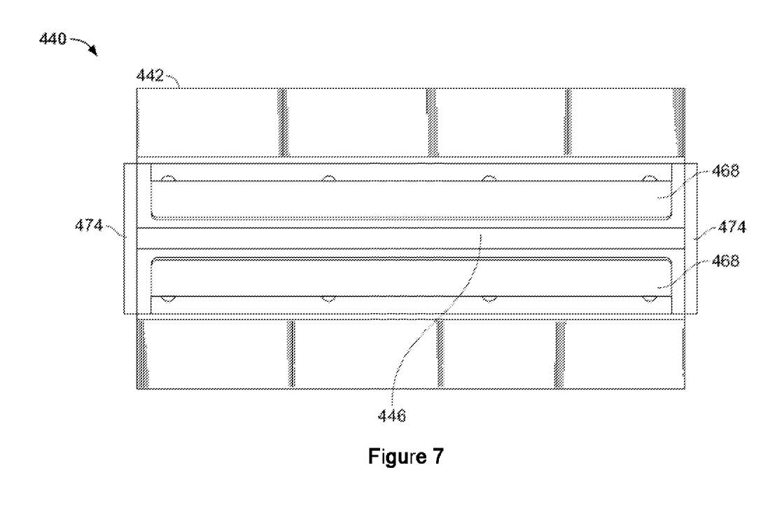

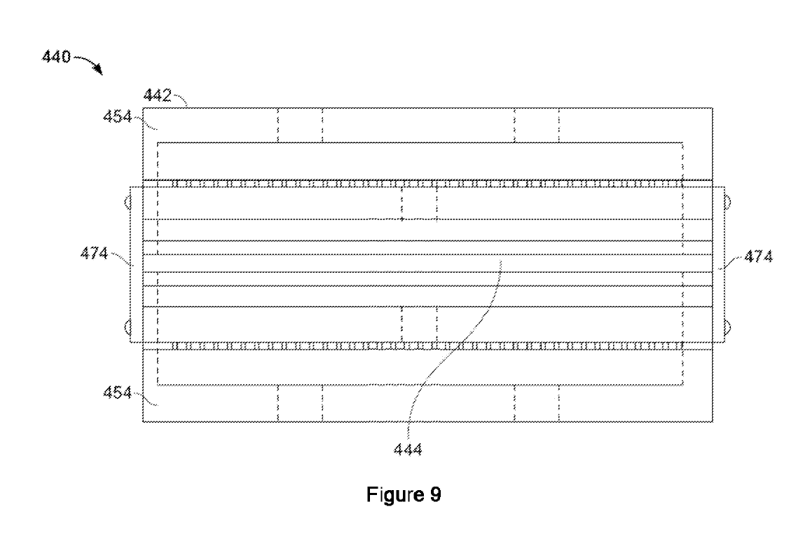

At one end, master air jet 440 includes inlet opening 444. As best seen in FIG. 9, inlet opening 444 may have a generally rectangular configuration that corresponds generally to the shape of die configuration. Housing 442 also includes outlet opening 446 which, as best seen in FIG. 7, may also have a rectangular configuration that corresponds to the desired shape of the bulked web leaving master air jet 440.

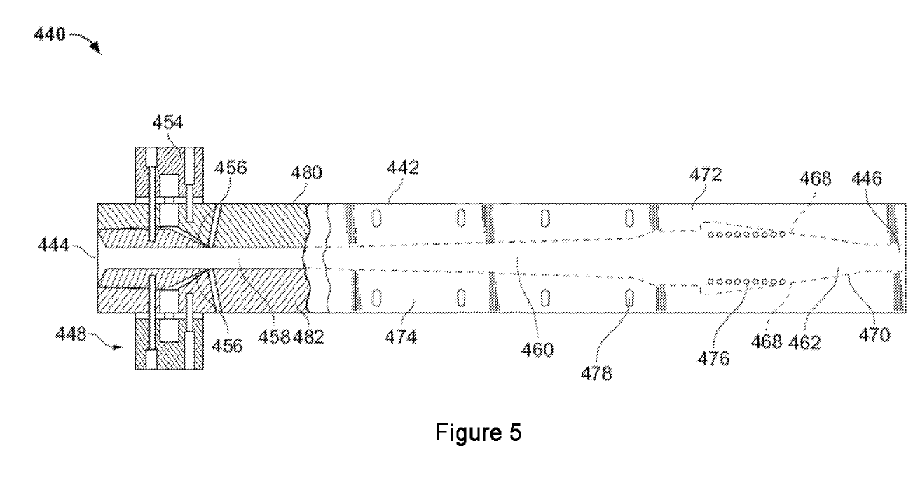

Air jet 448 may be formed adjacent the inlet end of housing 442 and may include a source of compressed air (or other fluid in some embodiments) and a conventional control valve for regulating the flow of compressed air from the compressed air source to air manifold 454 through which the compressed air is delivered to jet orifices 456. Jet orifices 456 may form a conventional jet of air for moving the polymer melt filaments through central passageway 458 in housing 442 as will be explained in greater detail herein. As best seen in FIG. 5, passageway 458 has a gradually increasing cross-sectional area in the direction of movement of the polymer melt filaments so as to provide forming chamber 460 downstream of air jet 448. Forming chamber 460 may also preferably have a generally rectangular configuration.

Accumulating chamber 462 may be located adjacent the outlet end of housing 442 and downstream of forming chamber 460 and may have a vertical dimension which is greater than outlet opening 446 of forming chamber 460. Accumulating chamber 462 may also be preferably formed with a rectangular configuration to permit the polymer melt filaments to pass into accumulating chamber 462 from forming chamber 460 to accumulate within accumulating chamber 462. Ultimately the polymer melt filaments may be withdrawn from housing 442 through outlet opening 446 at different flow rates yielding a bulked web.

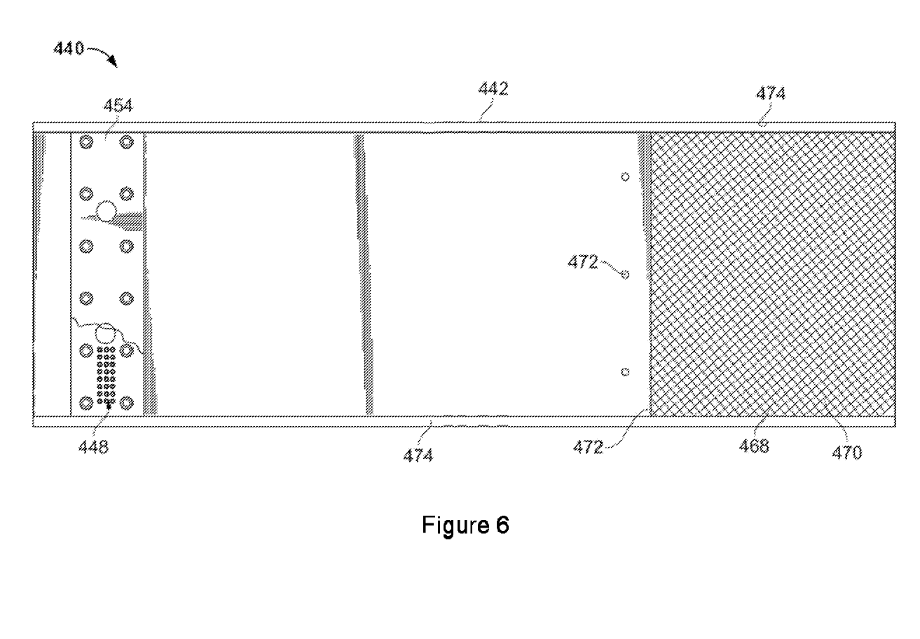

As best seen in FIGS. 5 and 6, a pair of perforated plates 468, each having a large number of perforations 470 therein, may be disposed in accumulating chamber 462 and in side plates 474 between forming chamber 460 and accumulating chamber 462. Perforated plates 468 may be fixed in place to top plate 480 and bottom plate 482 by a plurality of bolts 472 that maintain perforated plates 468 in fixed positions to form accumulating chamber 462.

The size of forming chamber 460 and accumulating chamber 462 may be involved in determining the caliper of the bulked web produced from master air jet 440. Sizing guides 478 along side plates 474 allow for increasing or decreasing the size of forming chamber 460. It should be noted that the configuration of sizing guides 478 along side pates 474 may allow for changing the size of forming chamber 460 by different amounts by angling top plate 480 relative to bottom plate 482. Varying the shape and/or positions of perforated plates 468 the size of accumulating chamber 462 may be varied.

Similarly, the size of inlet opening 444 and outlet opening 446 may be adjusted using sizing guides 478 along side plates 474 or varying the position and/or shape of perforated plates 468. Variable sizing of inlet opening 444 may advantageously allow for receiving more polymer melt filaments into master air jet 440. Also variable sizing of outlet opening 446 may advantageously allow for producing higher caliper bulked webs.

Side plates 474 may also have a plurality of perforations 476 located generally at a position where the carrier air leaves forming chamber 460 and enters accumulating chamber 462, whereby some of the carrier air can be discharged through perforations 476.

In the operation of master air jet 440, compressed air flows to air jet 448 at a flow rate controlled by the control valve, and the jet of air formed by orifices 456 may move the polymer melt filaments through forming chamber 460. As the polymer melt filaments move through forming chamber 460 by the carrier air, the carrier air may at least partially entangle the polymer melt filaments and create a web of polymer melt filaments so that it gradually increases in cross-sectional area in conformity with the gradually increasing cross-sectional area of forming chamber 460. When the polymer melt filaments exits forming chamber 460 and enters accumulating chamber 462, the web of polymer melt filaments bulks even further to correspond to the vertical distance between the upstream ends of perforated plates 468 (see FIG. 5).

While some of the carrier air may be discharged through perforations 476 in side plates 474, a substantial portion of the carrier air moves the web of polymer melt filaments through the spacing between perforated plates 468 and passes outwardly through perforations 470 in perforated plates 468. In so doing, the air passing outwardly through perforations 470 urges the web of polymer melt filaments into frictional engagement with the facing inner surfaces of perforated plates 468. This frictional engagement creates a braking action on the web of polymer melt filaments, which retards the movement of the web of polymer melt filaments through accumulating chamber 462 and causes the polymer melt filaments to accumulate in accumulating chamber 462 at a density greater than the web of polymer melt filaments had in forming chamber 460, after which the bulked and densified web of polymer melt filaments exits the accumulating chamber 462 as a bulked web through the outlet opening 446 at different flow rates.

The flow rate of the carrier air may determine the retarding or braking action applied to the web of polymer melt filaments as it passes between perforated plates 468. If the flow rate of the carrier air is increased, the carrier air passing outwardly through perforations 470 in perforated plates 468 will urge the web of polymer melt filaments into engagement with perforated plates 468 with a greater force, and may thereby increase the retarding or braking action that is applied to the web of polymer melt filaments. Conversely, if the flow rate of the carrier air is decreased, there will be a smaller braking action applied to the web of polymer melt filaments. Therefore, virtually infinite regulation of the braking action may be obtained by the simple expedient of operating the control valve to provide a flow of carrier air that provides the desired braking action imposed on the web of polymer melt filaments, and thereby controls the density and caliper of the bulked web as it leaves housing 442.

In some embodiments, master air jets of the present invention may have hinged side plates. Hinged side plates may advantageously allow for starting the extrusion of the polymer melt filaments (and passing through any other option components prior to or after the master air jet) before starting the air jets and forming the Venturi. Once all components of the desired system of the present invention are in place, the hinged side plates with the air jets operating may be closed so as to create the Venturi that then operates to transport the polymer melt filaments through the master air jet and form bulked webs.

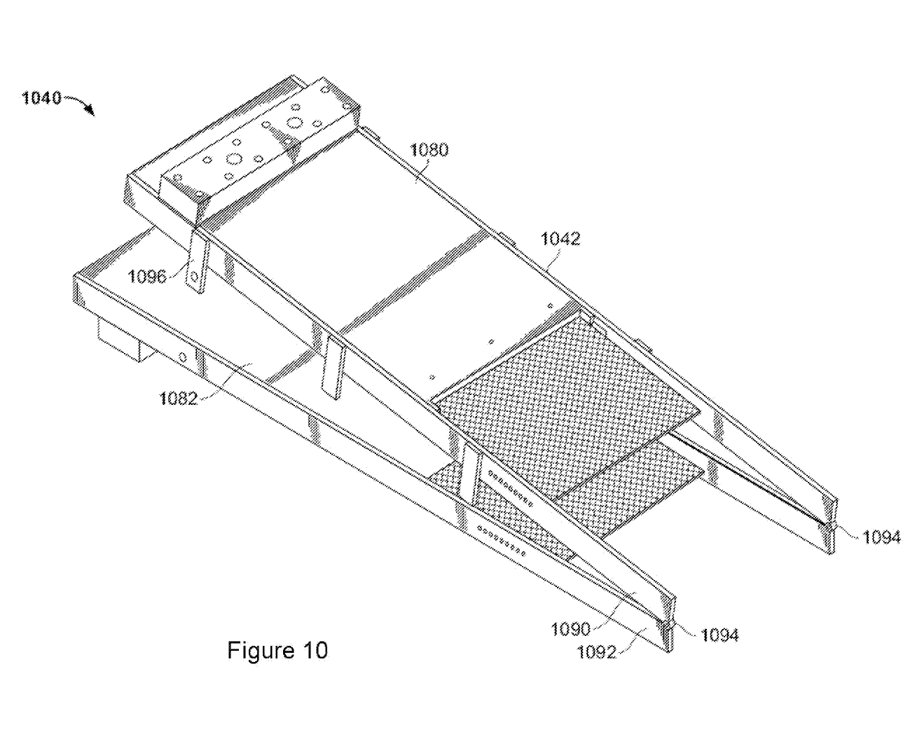

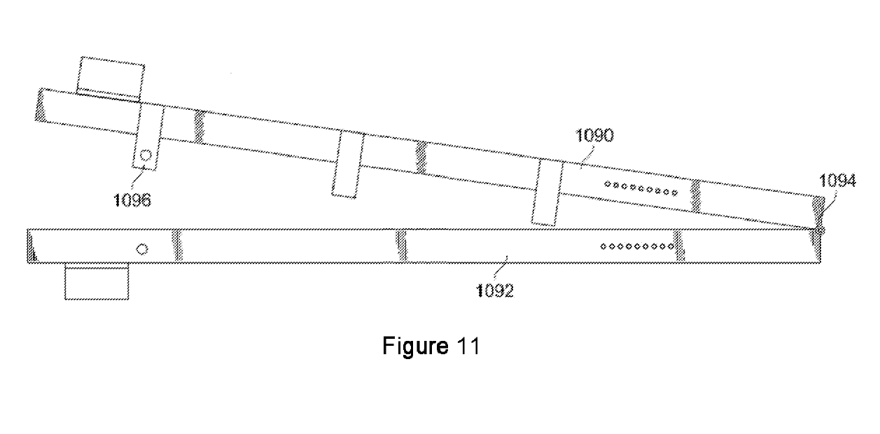

Referring now to FIGS. 10-11, nonlimiting examples of a master air jet of the present invention and components thereof, master air jet 1040 may have a pair of hinged side plates having side plate top half 1090 and side plate bottom half 1092, and side plate hinge 1094. Housing 1042 may be generally formed by top plate 1080 operably attached to side plate top half 1090 and bottom plate 1082 operably attached to side plate bottom half 1092. It should be noted that side, top, and bottom to modify the plates (or components thereof) are used for simplicity in describing the master air jet and should not be taken to be limiting as to the relation of the master air jet to the plane of the ground.

The side plates may have side plate guides 1096 operably attached to either side plate top half 1090 and side plate bottom half 1092 (not shown) to ensure proper alignment when the side plates are closed. To keep the side plate halves 1090 and 1092 closed during operation, at least one side plate guide 1096 may be capable of operably attaching to both side plate halves 1090 and 1092. As shown in FIGS. 10-11, one side plate guide 1096 is attached to side plate top half 1090 and has a hole that lines up with a threaded hole in side plate bottom half 1092 allowing for a bolt to secure side plate halves 1090 and 1092 in the closed position.

One skilled in the art should recognize the plurality of modification to hinged side plates that achieve the same function of the master air jet, e.g., side plate halves with grooves rather than side plate guides to ensure proper alignment. Further, one skilled in the art should recognize that during operation polymer melt filaments passing through the master air jet may snag on some imperfections (e.g., burs or gaps) in the side plates, especially at high air jet speeds. Snagging has the potential to adversely affect the edges of the bulked webs produced and, in some cases, cause inoperability of the master air jet.

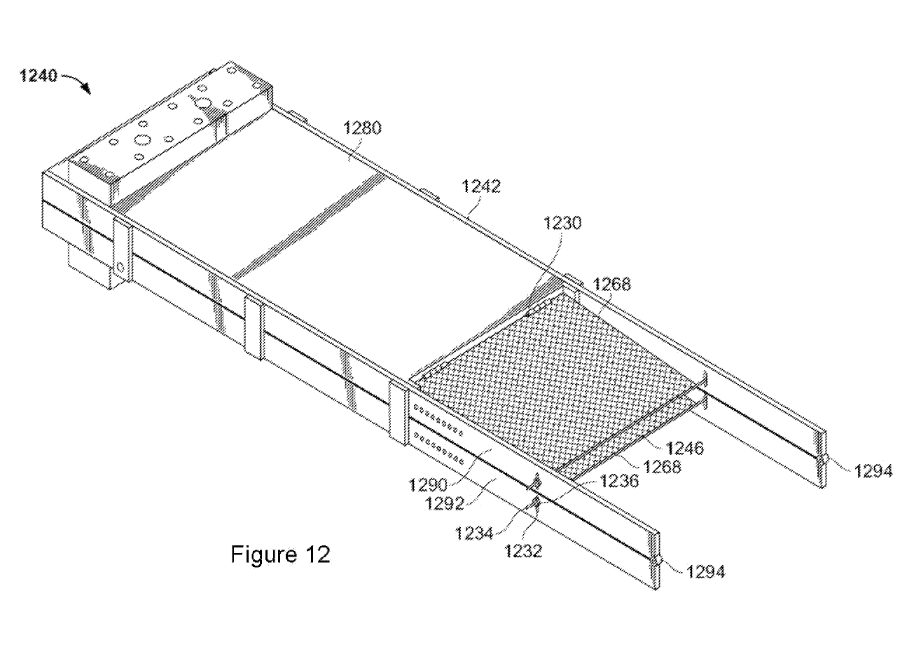

In some embodiments, master air jets of the present invention may have a sizeable outlet opening. Referring now to FIG. 12, a nonlimiting example of a master air jet of the present invention and components thereof, master air jet 1240 may include housing 1242 that generally is formed by a pair of side plates having side plate top half 1290 and side plate bottom half 1292 with side plate hinge 1294; top plate 1280 operably attached to side plate top half 1290, and bottom plate 1282 (not shown) operably attached to side plate bottom half 1292. Accumulating chamber 1262 (not shown) is formed by a pair of perforated plates 1268 fixed in place to top plate 1280 and bottom plate 1282 by hinges 1230 that allow for sizing outlet 1246 by fixing perforated plates 1268 into position by securing perforated plate sizing rods 1234 in outlet sizing guides 1232 with nut 1236.

One skilled in the art should recognize the plurality of modification to hinged perforated plates that achieve the same function of the master air jet, e.g., vertical screws to adjust the location of the perforated plates and consequently the size of the outlet opening on the fly. One skilled in the art should recognize the modifications should maintain the intended purpose of the perforated plates, i.e., provide a brake for the web of polymer melt filaments passing therethrough so as to create the bulk of the subsequent bulked web.

In some embodiments, master air jets of the present invention may have any combination of the features including, but not limited to, adjustable side plates, hinged side plates, and a sizeable outlet opening.

In some embodiments, master air jets of the present invention may be configured with an inlet opening having dimensions of width ranging from a lower limit of about 5 cm, 10 cm, 25 cm, or 50 cm to an upper limit of about 10 m, 5 m, 1 m (100 cm), or 50 cm, and wherein the inlet opening width may range from any lower limit to any upper limit and encompass any subset therebetween. In some embodiments, master air jets of the present invention may be configured with an inlet opening having dimensions of height ranging from a lower limit of about 0.5 cm, 1 cm, 2 cm, or 3 cm to an upper limit of about 5 cm, 4 cm, or 3 cm, and wherein the inlet opening height may range from any lower limit to any upper limit and encompass any subset therebetween.

In some embodiments, master air jets of the present invention may be configured with an outlet opening having dimensions of width ranging from a lower limit of about 5 cm, 10 cm, 25 cm, or 50 cm to an upper limit of about 10 m, 5 m, 1 m (100 cm), or 50 cm, and wherein the outlet opening width may range from any lower limit to any upper limit and encompass any subset therebetween. In some embodiments, master air jets of the present invention may be configured with an outlet opening having dimensions of height ranging from a lower limit of about 2 mm, 3 mm, 5 mm, 10 mm, 15 mm, 25 mm, or 50 mm to an upper limit of about 250 mm, 200 mm, 150 mm, 100 mm, or 50 mm, and wherein the outlet opening height may range from any lower limit to any upper limit and encompass any subset therebetween.

In some embodiments of the present invention, two or more master air jets may be in series. Because master air jets produce bulked webs with increased caliper, the dimensions of the inlet of the second (or greater) master air jet in a series should be appropriately sized. It should be noted that the Venturi in the master air jet may create some tension on the bulked webs being received from a previous master air jet. As such, the caliper of the bulked web may be less entering the master air jet than the caliper of the bulked web leaving the previous master air jet. Further, to control the proper transfer from one master air jet to another, one skilled in the art should recognize the potential apparatuses and/or machinery that may assist with ensuring the second (or greater) master air jet does not create too much tension on the bulked web so as to hinder the proper operation of the previous master air jet. By way of a nonlimiting example, tension rollers may be used for proper transfer between master air jets.

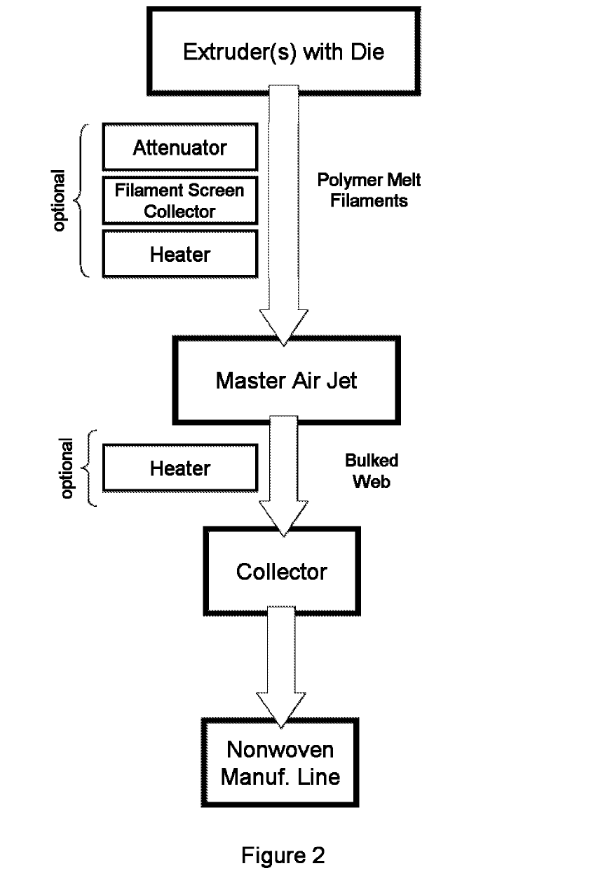

Referring now to an embodiment illustrated in FIG. 2, a nonlimiting example of the components of systems, in some embodiments systems of the present invention may include at least one extruder having a plurality of dies capable of producing polymer melt filaments, at least one master air jet of the present invention in communication with the extruder to receive the polymer melt filaments, and a collector in communication with the master air jet to receive the bulked web. Optionally, systems may further comprise apparatuses including, but not limited to, an attenuator, a filament collector screen, a heater, or any combination thereof. Optionally after the collector, systems may further comprise nonwoven manufacturing lines.

In some embodiments of the present invention, systems may optionally include an attenuator. As used herein, the term “attenuator” refers to an apparatus that, usually with the assistance of a moving fluid, reduces the diameter of filaments before the filaments have solidified. It should be noted that the master air jet described herein differs from an attenuator in many ways including, for example, that the master air jet does not substantially attenuate the polymer melt filaments. By way of nonlimiting example, the parameters of a master air jet and temperature of the polymer melt filaments may be controlled so as to provide for less than 5% attenuation of the polymer melt filaments. By way of nonlimiting example, the parameters of an attenuator and temperature of the polymer melt filaments may be controlled so as to provide for more than 75% attenuation of the polymer melt filaments. In some embodiments, systems for producing bulked webs of the present invention having polymer melt filaments may comprise at least one extruder having a plurality of dies, at least one attenuator, and at least one master air jet of the present invention.

In some embodiments of the present invention, systems may optionally include a filament collector screen. In some embodiments of the present invention, systems may optionally include a filament collector screen capable of continuous movement, e.g., like a conveyor. In some embodiments of the present invention, systems may optionally include applying a voltage across the die and the filament collector screen which may be advantageous for smaller diameter polymer melt filaments. Generally, filaments having been extruded using a voltage difference will be referred to herein as electrospun filaments. Some embodiments may involve extruding polymer melt filaments to a moving filament collector screen where there is a charge difference between the die and the filament collector screen, transporting the extruded filaments to a master air jet, and producing a bulked web. In some embodiments of the present invention, systems for producing bulked webs having polymer melt filaments may comprise at least one extruder having a plurality of dies, at least one filament collector screen, and at least one master air jet. In some embodiments of the present invention, systems for producing bulked webs having polymer melt filaments may comprise at least one extruder having a plurality of dies, at least one filament collector screen where at least one of the dies and at least one of the filament collector screens have a voltage applied thereacross, and at least one master air jet.

In some embodiments of the present invention, systems may optionally include heating elements. Heating elements may be in thermal communication with polymer melt filaments at any point along a system including, but not limited to, after the extruder, in the attenuator, after the attenuator, in the master air jet, after the master air jet, or any combination thereof. Heating may be achieved with radiant heat, conductive heat, convective heat, or any combination thereof. Suitable heating elements may include, but not be limited to, heated fluids (gases or liquids), steam, heated inert gasses, secondary radiation form nanoparticles, ovens, furnaces, thermoelectric elements, and the like, or any combination thereof. In some embodiments of the present invention, heated inert gases may be used to mitigate any unwanted oxidation of the polymer melt filaments or any component thereof. In some embodiments of the present invention, heated gases, inert or otherwise, may be passed through the master air jet. Secondary radiation from nanoparticles may be achieved by irradiating nanoparticles with electromagnetic radiation, e.g., gamma-rays, x-rays, UV light, visible light, IR light, microwaves, radio waves, and/or long radio waves. By way of nonlimiting example, polymer melt filaments may comprise carbon nanotubes that when irradiated with radio frequency waves emit heat. One skilled in the art, with the benefit of this disclosure, should understand that different wavelengths of electromagnetic radiation penetrate materials to different depths. Therefore, when employing nanoparticles for production of secondary radiation one should consider the mold cavity configuration and composition, the matrix material composition, the nanoparticle, the wavelength of electromagnetic radiation, the intensity of the electromagnetic radiation, the irradiation methods, and the desired amount of secondary radiation, e.g., heat. In some embodiments of the present invention, systems for producing bulked webs having polymer melt filaments may comprise at least one extruder having a plurality of dies, at least one heating element, and at least one master air jet.

In some embodiments of the present invention, systems may optionally include collectors. Suitable collectors may include, but not be limited to, mandrels or the like for collecting rolls of bulked webs, containers or the like for collecting laid bulked webs, conveyors or the like for collecting and transporting bulked webs, and the like. Some embodiments may involve collecting the bulked webs for storage and/or transporting (e.g., shipping). Some embodiments may involve transporting the bulked webs for further processing. Some embodiments may involve transporting a bulked web to a nonwoven manufacturing line (described further herein). In some embodiments of the present invention, systems for producing bulked webs having polymer melt filaments may comprise at least one extruder having a plurality of dies, at least one collector, and at least one master air jet.

In some embodiments, bulked webs of the present invention may comprise one or more types of filaments. As used herein, filament “types,” and the like, refers to filaments having substantially the same composition and diameter. In some embodiments, bulked webs may comprise polymer melt filaments and non-polymer melt filaments. Examples of non-polymer melt filaments may include, but not be limited to, natural filaments (e.g., cotton fibers), solvent spun filaments (e.g., cellulose acetate filaments), bicomponent filaments, carbon filaments, metal filaments, ceramic filaments, glass filaments, and the like.

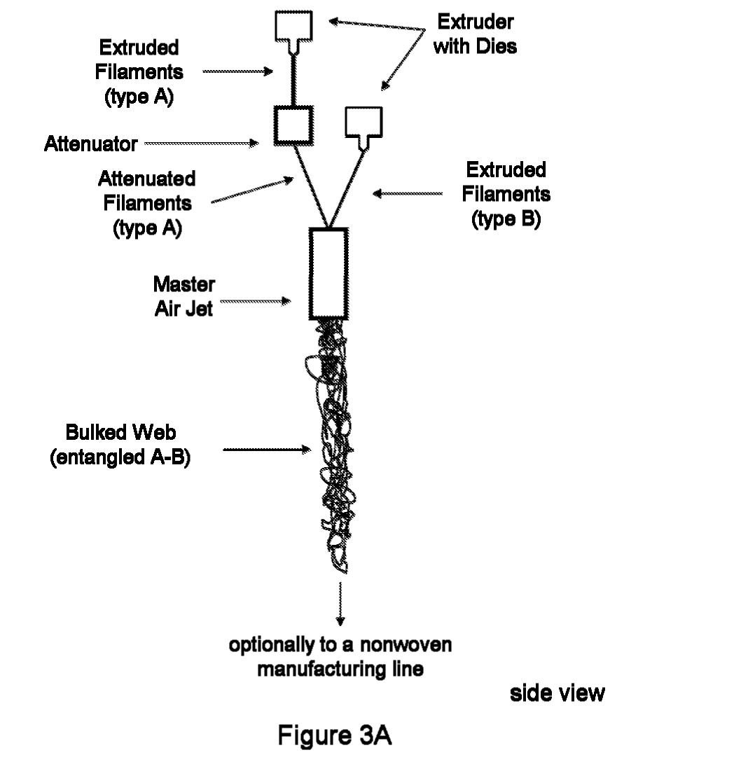

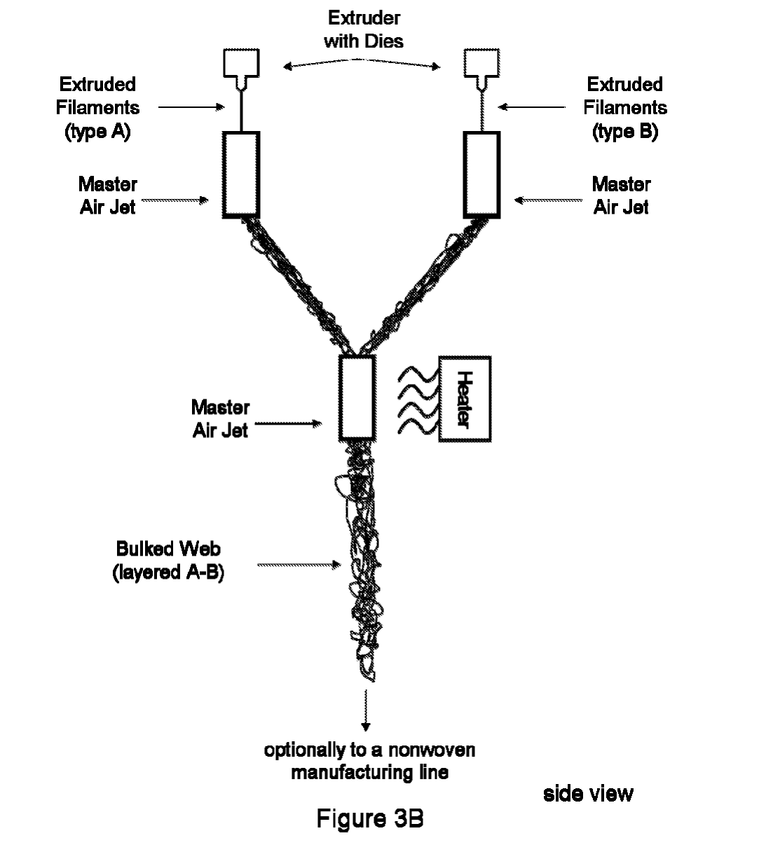

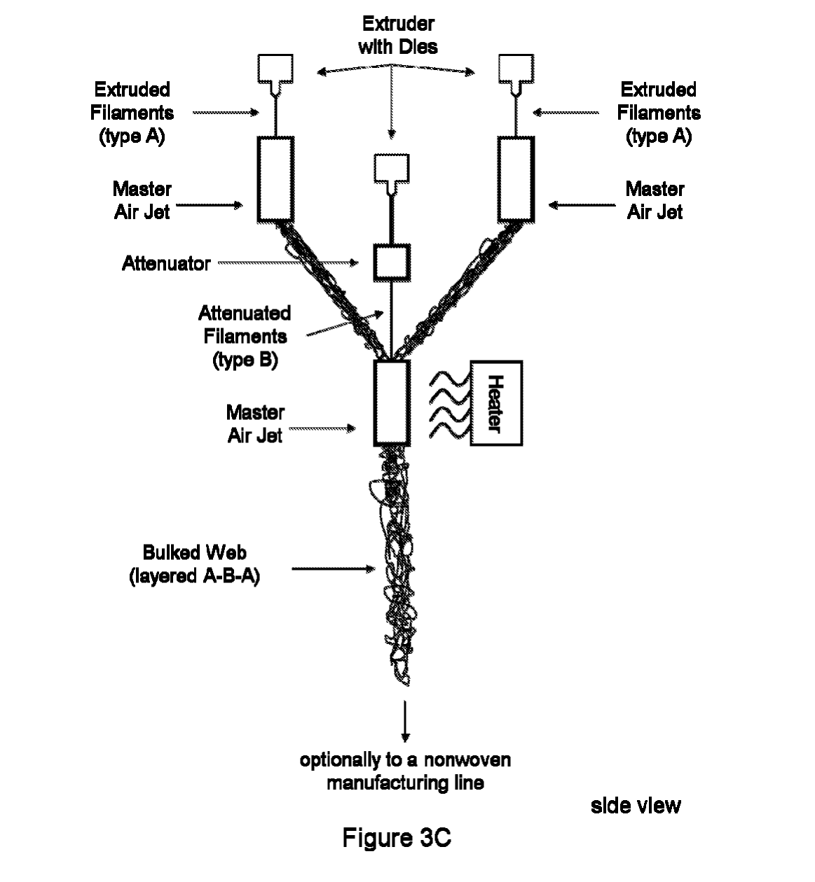

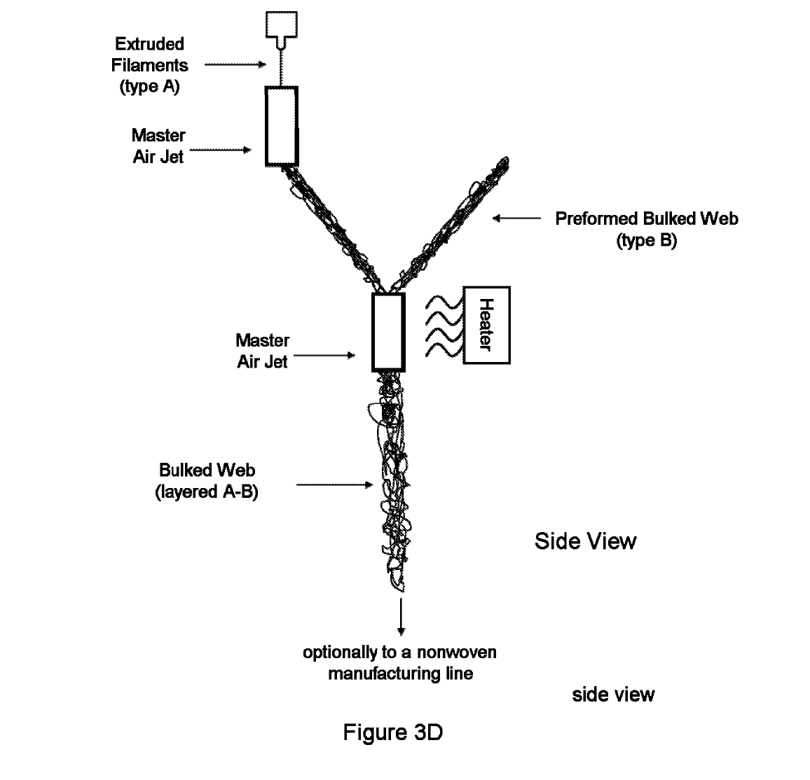

In some embodiments, systems may include more than one extruder with dies. In some embodiments, systems may include master air jets for receiving more than one type of polymer melt filament. In some embodiments, master air jets may receive six or more polymer melt filament types. By way of nonlimiting example illustrated in FIG. 3A, systems may include extruders for producing polymer melt filaments of type A and type B separately and simultaneously. Said polymer melt filaments may be introduced into a master air jet to produce a bulked web having a cross-sectional makeup of entangled polymer melt filaments of types A and B. As shown in FIG. 3A, polymer melt filaments of type A may be attenuated.

In some embodiments, systems may include more than one master air jet. Some embodiments may involve producing a plurality of bulked webs in parallel then combining the plurality of bulked webs to form a single bulked web having a layered cross-sectional make-up. By way of nonlimiting example as illustrated in FIG. 3B, two types A and B may, in parallel, be extruded and formed into bulked webs, then a master air jet may entangle the two bulked webs together to form a bulked web with a layered cross-sectional make-up of A-B. As shown in FIG. 3B, the master air jet that entangles the bulked webs A and B is in thermal communication with a heating element. This may advantageously enhance mechanical bonding between the polymer melt filaments of bulked webs A and B.

In some embodiments, systems may include a master air jet capable of accepting both bulked webs and polymer melt filaments. By way of the nonlimiting embodiment illustrated in FIG. 3C, some embodiments may involve producing two bulked webs simultaneously in parallel then introducing into a master air jet the two bulked webs with polymer melt filaments (attenuated filaments as shown in FIG. 3C) between the two bulked webs to form a bulked web with a layered cross-sectional make-up. As shown in FIG. 3C, the two bulked webs formed from polymer melt filaments of type A and the polymer melt filaments of type B are brought together in a master air jet to form a bulked web with a layered cross-sectional make-up of A-B-A, for example.

In some embodiments, systems may include a master air jet capable of receiving preformed bulked webs, preformed filaments, bloomed tow bands, bulked tow bands, the like, or any combination thereof. By way of nonlimiting example, a preformed bulked web may be a bulked web formed from tow bands or bulked webs from polymer melt filaments that were formed and collected previously. In some embodiments as illustrated in FIG. 3D, a bulked web of polymer melt filaments of type A and a preformed bulked web of filaments of type B may be received by a master air jet to form a bulked web having a layered make-up of A-B.

In some embodiments, master air jets may receive polymer melt filaments, extruded filaments, electrospun filaments, attenuated filaments, preformed filaments, non-polymer melt filaments, bulked webs, preformed bulked webs, or any combination thereof in a configuration so as to form a single bulked web having a cross-sectional composition of entangled filaments, side-by-side regions of different types of filaments, layered regions of different types of filaments, or any combination thereof.

In some embodiments, the bulked webs of the present invention or made by the methods of the present invention may have a caliper of about 2 mm or greater. In some embodiments, the bulked webs of the present invention or made by the methods of the present invention may have a caliper ranging from a lower limit of about 2 mm, 3 mm, 5 mm, 10 mm, 15 mm, 25 mm, or 50 mm to an upper limit of about 250 mm, 200 mm, 150 mm, 100 mm, or 50 mm, and wherein the caliper of the bulked webs of the present invention or made by the methods of the present invention may range from any lower limit to any upper limit and encompass any subset therebetween.

In some embodiments, the bulked webs of the present invention or made by the methods of the present invention may have a bulk density of about 0.05 g/cm³ or less. In some embodiments, the bulked webs of the present invention or made by the methods of the present invention may have a bulk density ranging from a lower limit of about 0.005 or 0.01 g/cm³ to an upper limit of about 0.1, 0.05, or 0.01 g/cm³, and wherein the bulk density of the bulked webs of the present invention or made by the methods of the present invention may range from any lower limit to any upper limit and encompass any subset therebetween.

In some embodiments, the bulked webs of the present invention or made by the methods of the present invention may have a width ranging from a lower limit of about 5 cm, 10 cm, 25 cm, or 50 cm to an upper limit of about 10 m, 5 m, 1 m (100 cm), or 50 cm, and wherein the width may range from any lower limit to any upper limit and encompass any subset therebetween. In some embodiments, bulked webs of the present invention may have a width of about 15 cm or greater. In some embodiments, bulked webs of the present invention may have a width of about 30 cm or greater. In some embodiments, bulked webs of the present invention may have a width of about 50 cm or greater. In some embodiments, bulked webs of the present invention may have a width of about 1 m or greater.

In some embodiments, bulked webs of the present invention may be the nonwoven materials with no further processing. In some embodiments of the present invention, systems for producing nonwoven materials of the present invention from polymer melt filaments may comprise at least one extruder having a plurality of dies and a master air jet.

Some embodiments may involve producing a nonwoven material from the bulked webs of the present invention. In some embodiments, systems for producing the bulked webs of the present invention may comprise at least one extruder having a plurality of dies, at least one master air jet, and a nonwoven manufacturing line.

In some embodiments, nonwoven materials made from the bulked webs of the present invention may have a caliper of about 0.5 mm or greater. In some embodiments, nonwoven materials made from the bulked webs of the present invention or made by the methods of the present invention may have a caliper ranging from a lower limit of about 0.5 mm, 1 mm, 2 mm, 3 mm, 5 mm, 10 mm, 15 mm, 25 mm, or 50 mm to an upper limit of about 250 mm, 200 mm, 150 mm, 100 mm, or 50 mm, and wherein the caliper of nonwoven materials may range from any lower limit to any upper limit and encompass any subset therebetween.

In some embodiments, nonwoven materials made from the bulked webs of the present invention may have a bulk density of about 0.25 g/cm³ or less. In some embodiments, nonwoven materials made from the bulked webs of the present invention or made by the methods of the present invention may have a bulk density ranging from a lower limit of about 0.005, 0.01, or 0.05 g/cm³ to an upper limit of about 0.5, 0.25, 0.2, or 0.1 g/cm³, and wherein the bulk density of nonwoven materials may range from any lower limit to any upper limit and encompass any subset therebetween.

In some embodiments, nonwoven materials made from the bulked webs of the present invention may have a width substantially the same as the bulked webs from which it is produced. In some embodiments, nonwoven materials made from the bulked webs of the present invention or made by the methods of the present invention described herein may have a width ranging from a lower limit of about 5 cm, 10 cm, 25 cm, or 50 cm to an upper limit of about 10 m, 5 m, 1 m (100 cm), or 50 cm, and wherein the width may range from any lower limit to any upper limit and encompass any subset therebetween.

In some embodiments, nonwoven manufacturing lines that may be used in conjunction with the systems and methods of the present invention may generally include any processing areas and processing apparatuses in any configuration known to one skilled in the art. Suitable processing areas may include, but not be limited to, additive application areas, calendaring areas, hydroentanglement areas, resin-bonding areas, thermal bonding areas, through air bonding areas, crosslapping areas, drying areas, heating areas, cooling areas, collection areas, any hybrid thereof, or any combination thereof. Suitable processing apparatuses may include, but not be limited to, additive application apparatuses, calendaring apparatuses, hydroentanglement apparatuses, resin-bond apparatuses, thermal bonding apparatuses, through air bonding apparatuses, crosslapping apparatuses, drying apparatuses, thermal elements, collection apparatuses, any hybrid thereof, or any combination thereof. It should be noted that crosslapping may occur in any configuration using at least one selected from the group of bulked webs described herein, nonwoven materials described herein from polymer melt filaments, webs and/or nonwoven materials produced from carding lines, or any combination thereof. By way of nonlimiting example, a bulked web described herein of greater than about 100 mm in width may be crosslapped with webs produced from carding staple fibers in the production of a nonwoven material according the present invention. By way of another nonlimiting example, a nonwoven material produced from carding staple fibers may be crosslapped with nonwoven materials produced from polymer melt filaments as described herein in the production of a nonwoven material according the present invention.

Nonwoven materials made from the bulked webs of the present invention or made by the methods of the present invention can be manufactured to have a variety of characteristics including, but not limited to, colors, printable surfaces, high to low density, high to low absorbency of water or oil, high to low water-permeability, high to low air-permeability, high to low UV-permeability, rotting resistance, anti-bacterial surfaces, non-stick, corrosion resistance, abrasion resistance, abrasion enhancement, higher mechanical strength, textures, durability, lauderability, deformability (stretchability), electrostatic dissipation, fire retardation, and/or light diffusion. One skilled in the art should understand the necessary manufacturing requirements including the composition of the polymer melt filaments (and other types of filaments) from which the nonwoven material is produced, the inclusion of additives including when and how to apply the additives, and the manufacturing processes used to produce the nonwoven material.

Some embodiments may involve producing products from nonwoven materials produced from the bulked webs of the present invention or made by the methods of the present invention. In some embodiments of the present invention, systems may include product production lines capable of converting nonwoven materials into products. Nonlimiting examples of products that may be made from the bulked webs of the present invention may include hygiene products (e.g., baby diapers, incontinence products, feminine hygiene products), disposable medical products (e.g., gauze, bandages, band-aids, wound pads, orthopedic waddings, stoma products, adhesive plasters, compresses, tapes, wraps, masks, gowns, and shoe covers), insulation products (e.g., for thermal, acoustic, and/or vibration insulation) (e.g., clothing, packs, vehicles, textiles, and noise damping in ceilings and walls), furniture textiles (e.g., upholstery, bedware, and quilted products), sorbents (e.g., for automotive, chemical, emergency responders, or packaging) (e.g., rags, pads, wraps, medical supplies, and oil booms), horticulture products (e.g., covering to protect plants from extreme temperatures at night or day), tapes for use with cables (e.g., for water-blocking, electrically conductivity, or thermal barriers), composite materials (e.g., glass-fiber-reinforced plastics), surfacing products (e.g., pipes, tanks, container boards, facade panels, skis, surfboards, and boats), window treatments, shoe inserts (e.g., liners, counterliners, interliners, and reinforcing materials), the inside layer of tufted carpets and carpet tiles, carpet backings, fluid filters (e.g., configured as cartridges, cassettes, bags, sheets, mats, screens, and films) (e.g., milk filters, coolant filters, metal-processing filters, blood plasma filters, frying fat filters, drinking water filters, enzyme filters, vacuum filters, kitchen hood filters, respirator filters, appliance filters, furnace filters, high-temperature filters, activated carbon filters, and pocket filters), low density abrasives (e.g., hand pads, wipes, sponge laminates, floor pads, brushes, wools, wheels, and belts), polishing pads (e.g., for use in manufacturing semiconductor wafers, memory discs, precision optics, and metallurgical components), vehicle interiors (e.g., headliners, trunkliners, door trim, package trays, sunvisors, and seats), containers (e.g., bags), and the like.

One skilled in the art, with the benefit of this disclosure, will recognize the apparatuses or machinery capable for properly transporting the polymer filaments and bulked webs to, between, and/or from the extruder having a plurality of dies, the master air jet, and any additional processing areas or lines (e.g., collection areas, additive application areas, nonwoven manufacturing lines, product manufacturing lines, and the like). By way of nonlimiting examples, suitable apparatuses and/or machinery may include guides, rollers, reels, gears, conveyors, transfer belts, vacuums, air jets, and the like, any hybrid thereof, or any combination thereof. In some embodiments of the present invention, systems may include a conveyor for transporting a bulked web to a nonwoven manufacturing line.

Some embodiments may involve applying additives to polymer melt filaments, the bulked webs of the present invention or made by the methods of the present invention, or nonwoven materials produced from the bulked webs of the present invention or made by the methods of the present invention, products therefrom, or any combination thereof. Suitable additives are detailed further herein. In some embodiments of the present invention, systems for producing bulked webs from polymer melt filaments may include at least one additive application area. Additive application areas may be disposed before, along, and/or after extruders having a plurality of dies, attenuators, heaters, filament screen collectors, master air jets, collectors, nonwoven manufacturing lines, product production lines, or any combination thereof. It should be noted that applying includes, but is not limited to, dipping, immersing, submerging, soaking, rinsing, washing, painting, coating, showering, drizzling, spraying, placing, dusting, sprinkling, affixing, and any combination thereof. Further, it should be noted that applying includes, but is not limited to, surface treatments, infusion treatments where the additive incorporates at least partially into filaments, and any combination thereof.

Suitable additives for use in conjunction with the present invention may include, but not be limited to, active particles, active compounds, ion exchange resins, superabsorbent polymers, zeolites, nanoparticles, ceramic particles, abrasive particulates, absorbent particulates, softening agents, plasticizers, pigments, dyes, flavorants, aromas, controlled release vesicles, binders, adhesives, tackifiers, surface modification agents, lubricating agents, emulsifiers, vitamins, peroxides, biocides, antifungals, antimicrobials, deodorizers, antistatic agents, flame retardants, antifoaming agents, degradation agents, conductivity modifying agents, stabilizing agents, or any combination thereof. Said additives are detailed further herein.

Active particles for use in conjunction with the present invention may be useful in actively reducing components from a fluid stream by absorption or reaction. Suitable active particles for use in conjunction with the present invention may include, but not be limited to, nano-scaled carbon particles, carbon nanotubes having at least one wall, carbon nanohorns, bamboo-like carbon nanostructures, fullerenes, fullerene aggregates, graphene, few layer graphene, oxidized graphene, iron oxide nanoparticles, nanoparticles, metal nanoparticles, gold nanoparticles, silver nanoparticles, metal oxide nanoparticles, alumina nanoparticles, magnetic nanoparticles, paramagnetic nanoparticles, superparamagnetic nanoparticles, gadolinium oxide nanoparticles, hematite nanoparticles, magnetite nanoparticles, gado-nanotubes, endofullerenes, Gd@C₆₀, core-shell nanoparticles, onionated nanoparticles, nanoshells, onionated iron oxide nanoparticles, activated carbon, ion exchange resins, desiccants, silicates, molecular sieves, silica gels, activated alumina, zeolites, perlite, sepiolite, Fuller's Earth, magnesium silicate, metal oxides, iron oxides, activated carbon, and any combination thereof.

Suitable active particles for use in conjunction with the present invention may have at least one dimension of about less than one nanometer, such as graphene, to as large as a particle having a diameter of about 5000 nanometers. Active particles for use in conjunction with the present invention may range from a lower size limit in at least one dimension of about: 0.1 nanometers, 0.5 nanometers, 1 nanometer, 10 nanometers, 100 nanometers, 500 nanometers, 1 micron, 5 microns, 10 microns, 50 microns, 100 microns, 150 microns, 200 microns, and 250 microns. The active particles may range from an upper size limit in at least one dimension of about: 5000 microns, 2000 microns, 1000 microns, 900 microns, 700 microns, 500 microns, 400 microns, 300 microns, 250 microns, 200 microns, 150 microns, 100 microns, 50 microns, 10 microns, and 500 nanometers. Any combination of lower limits and upper limits above may be suitable for use in conjunction with the present invention, wherein the selected maximum size is greater than the selected minimum size. In some embodiments, the active particles for use in conjunction with the present invention may be a mixture of particle sizes ranging from the above lower and upper limits. In some embodiments of the present invention, the size of the active particles may be polymodal.

Active compounds for use in conjunction with the present invention may be useful in actively reducing components from a fluid stream by absorption or reaction. Suitable active compounds for use in conjunction with the present invention may include, but not be limited to, malic acid, potassium carbonate, citric acid, tartaric acid, lactic acid, ascorbic acid, polyethyleneimine, cyclodextrin, sodium hydroxide, sulphamic acid, sodium sulphamate, polyvinyl acetate, carboxylated acrylate, or any combination thereof.

Suitable ion exchange resins for use in conjunction with the present invention may include, but not be limited to, polymers with a backbone, such as styrene-divinyl benezene (DVB) copolymer, acrylates, methacrylates, phenol formaldehyde condensates, and epichlorohydrin amine condensates; a plurality of electrically charged functional groups attached to the polymer backbone; or any combination thereof.

As used herein, the term “superabsorbent materials” refers to materials, e.g., polymers, capable of absorbing at least three times their weight of a fluid. Suitable superabsorbent materials for use in conjunction with the present invention may include, but not be limited to, sodium polyacrylate, starch graved copolymers of polyacrylonitriles, polyvinyl alcohol copolymers, cross-linked poly(ethylene oxides), polyacrylamide copolymers, ethylene maleic anhydride copolymers, cross-linked carboxymethylcelluloses, and the like, or any combination thereof. By way of nonlimiting example, superabsorbent materials incorporated into a nonwoven may be useful in chemical spill rags and kits.

Zeolites for use in conjunction with the present invention may include crystalline aluminosilicates having pores, e.g., channels, or cavities of uniform, molecular-sized dimensions. Zeolites may include natural and synthetic materials. Suitable zeolites may include, but not be limited to, zeolite BETA (Na₇(Al₇Si₅₇O₁₂₈) tetragonal), zeolite ZSM-5 (Naₙ(AlₙSi₉₆₋ₙO₁₉₂) 16 H₂O, with n<27), zeolite A, zeolite X, zeolite Y, zeolite K-G, zeolite ZK-5, zeolite ZK-4, mesoporous silicates, SBA-15, MCM-41, MCM48 modified by 3-aminopropylsilyl groups, alumino-phosphates, mesoporous aluminosilicates, other related porous materials (e.g., such as mixed oxide gels), or any combination thereof.

Suitable nanoparticles for use in conjunction with the present invention may include, but not be limited to, nano-scaled carbon particles like carbon nanotubes of any number of walls, carbon nanohorns, bamboo-like carbon nanostructures, fullerenes and fullerene aggregates, and graphene including few layer graphene and oxidized graphene; metal nanoparticles like gold and silver; metal oxide nanoparticles like alumina, silica, and titania; magnetic, paramagnetic, and superparamagentic nanoparticles like gadolinium oxide, various crystal structures of iron oxide like hematite and magnetite, about 12 nm Fe₃O₄, gado-nanotubes, and endofullerenes like Gd@C₆₀; and core-shell and onionated nanoparticles like gold and silver nanoshells, onionated iron oxide, and others nanoparticles or microparticles with an outer shell of any of said materials; and any combination of the foregoing. It should be noted that nanoparticles may include nanorods, nanospheres, nanorices, nanowires, nanostars (like nanotripods and nanotetrapods), hollow nanostructures, hybrid nanostructures that are two or more nanoparticles connected as one, and non-nano particles with nano-coatings or nano-thick walls. It should be further noted that nanoparticles for use in conjunction with the present invention may include the functionalized derivatives of nanoparticles including, but not limited to, nanoparticles that have been functionalized covalently and/or non-covalently, e.g., pi-stacking, physisorption, ionic association, van der Waals association, and the like. Suitable functional groups may include, but not be limited to, moieties comprising amines (1°, 2°, or) 3°, amides, carboxylic acids, aldehydes, ketones, ethers, esters, peroxides, silyls, organosilanes, hydrocarbons, aromatic hydrocarbons, and any combination thereof; polymers; chelating agents like ethylenediamine tetraacetate, diethylenetriaminepentaacetic acid, triglycollamic acid, and a structure comprising a pyrrole ring; and any combination thereof.

Suitable ceramic particles for use in conjunction with the present invention may include, but not be limited to, oxides (e.g., silica, titania, alumina, beryllia, ceria, and zirconia), nonoxides (e.g., carbides, borides, nitrides, and silicides), composites thereof, or any combination thereof. Ceramic particles may be crystalline, non-crystalline, or semi-crystalline.

Suitable softening agents and/or plasticizers for use in conjunction with the present invention may include, but not be limited to, water, glycerol triacetate (triacetin), triethyl citrate, dimethoxy-ethyl phthalate, dimethyl phthalate, diethyl phthalate, methyl phthalyl ethyl glycolate, o-phenyl phenyl-(bis) phenyl phosphate, 1,4-butanediol diacetate, diacetate, dipropionate ester of triethylene glycol, dibutyrate ester of triethylene glycol, dimethoxyethyl phthalate, triethyl citrate, triacetyl glycerin, and the like, any derivative thereof, and any combination thereof. One skilled in the art with the benefit of this disclosure should understand the concentration of plasticizers to use as an additive to the filaments.

As used herein, pigments refer to compounds and/or particles that impart color and are incorporated throughout the filaments. Suitable pigments for use in conjunction with the present invention may include, but not be limited to, titanium dioxide, silicon dioxide, carbon black, tartrazine, E102, phthalocyanine blue, phthalocyanine green, quinacridones, perylene tetracarboxylic acid di-imides, dioxazines, perinones disazo pigments, anthraquinone pigments, carbon black, metal powders, iron oxide, ultramarine, calcium carbonate, kaolin clay, aluminum hydroxide, barium sulfate, zinc oxide, aluminum oxide, caramel, fruit or vegetable or spice colorants (e.g., beet powder, beta-carotene, turmeric, paprika), or any combination thereof.

As used herein, dyes refer to compounds and/or particles that impart color and are a surface treatment of the filaments. Suitable dyes for use in conjunction with the present invention may include, but not be limited to, CARTASOL® dyes (cationic dyes, available from Clariant Services) in liquid and/or granular form (e.g., CARTASOL® Brilliant Yellow K-6G liquid, CARTASOL® Yellow K-4GL liquid, CARTASOL® Yellow K-GL liquid, CARTASOL® Orange K-3GL liquid, CARTASOL® Scarlet K-2GL liquid, CARTASOL® Red K-3BN liquid, CARTASOL® Blue K-5R liquid, CARTASOL® Blue K-RL liquid, CARTASOL® Turquoise K-RL liquid/granules, CARTASOL® Brown K-BL liquid), FASTUSOL® dyes (an auxochrome, available from BASF) (e.g., Yellow 3GL, Fastusol C Blue 74L).

Suitable flavorants for use in conjunction with the present invention may include, but not be limited to, organic material (or naturally flavored particles), carriers for natural flavors, carriers for artificial flavors, and any combination thereof. Organic materials (or naturally flavored particles) include, but are not limited to, tobacco, cloves (e.g., ground cloves and clove flowers), cocoa, and the like. Natural and artificial flavors may include, but are not limited to, menthol, cloves, cherry, chocolate, orange, mint, mango, vanilla, cinnamon, tobacco, and the like. Such flavors may be provided by menthol, anethole (licorice), anisole, limonene (citrus), eugenol (clove), and the like, or any combination thereof. In some embodiments, more than one flavorant may be used including any combination of the flavorants provided herein. These flavorants may be placed in the tobacco column or in a section of a filter.

Suitable aromas for use in conjunction with the present invention may include, but not be limited to, methyl formate, methyl acetate, methyl butyrate, ethyl acetate, ethyl butyrate, isoamyl acetate, pentyl butyrate, pentyl pentanoate, octyl acetate, myrcene, geraniol, nerol, citral, citronellal, citronellol, linalool, nerolidol, limonene, camphor, terpineol, alpha-ionone, thujone, benzaldehyde, eugenol, cinnamaldehyde, ethyl maltol, vanilla, anisole, anethole, estragole, thymol, furaneol, methanol, or any combination thereof.

Suitable binders for use in conjunction with the present invention may include, but not be limited to, polyolefins, polyesters, polyamides (or nylons), polyacrylics, polystyrenes, polyvinyls, polytetrafluoroethylene (PTFE), polyether ether ketone (PEEK), any copolymer thereof, any derivative thereof, and any combination thereof. Non-fibrous plasticized cellulose derivatives may also be suitable for use as binder particles in the present invention. Examples of suitable polyolefins may include, but not be limited to, polyethylene, polypropylene, polybutylene, polymethylpentene, and the like, any copolymer thereof, any derivative thereof, and any combination thereof. Examples of suitable polyethylenes may include, but not be limited to, ultrahigh molecular weight polyethylene, very high molecular weight polyethylene, high molecular weight polyethylene, low-density polyethylene, linear low-density polyethylene, high-density polyethylene, and the like, any copolymer thereof, any derivative thereof, and any combination thereof. Examples of suitable polyesters may include, but not be limited to, polyethylene terephthalate, polybutylene terephthalate, polycyclohexylene dimethylene terephthalate, polytrimethylene terephthalate, and the like, any copolymer thereof, any derivative thereof, and any combination thereof. Examples of suitable polyacrylics may include, but not be limited to, polymethyl methacrylate, and the like, any copolymer thereof, any derivative thereof, and any combination thereof. Examples of suitable polystyrenes may include, but not be limited to, polystyrene, acrylonitrile-butadiene-styrene, styrene-acrylonitrile, styrene-butadiene, styrene-maleic anhydride, and the like, any copolymer thereof, any derivative thereof, and any combination thereof. Examples of suitable polyvinyls may include, but not be limited to, ethylene vinyl acetate, ethylene vinyl alcohol, polyvinyl chloride, and the like, any copolymer thereof, any derivative thereof, and any combination thereof. Examples of suitable cellulosics may include, but not be limited to, cellulose acetate, cellulose acetate butyrate, plasticized cellulosics, cellulose propionate, ethyl cellulose, and the like, any copolymer thereof, any derivative thereof, and any combination thereof. In some embodiments, binder particles may comprise any copolymer, any derivative, or any combination of the above listed binders. Further, binder particles may be impregnated with and/or coated with any combination of additives disclosed herein.

Suitable tackifiers for use in conjunction with the present invention may include, but not be limited to, methylcellulose, ethylcellulose, hydroxyethylcellulose, carboxy methylcellulose, carboxy ethylcellulose, water-soluble cellulose acetate, amides, diamines, polyesters, polycarbonates, silyl-modified polyamide compounds, polycarbamates, urethanes, natural resins, shellacs, acrylic acid polymers, 2-ethylhexylacrylate, acrylic acid ester polymers, acrylic acid derivative polymers, acrylic acid homopolymers, anacrylic acid ester homopolymers, poly(methyl acrylate), poly(butyl acrylate), poly(2-ethylhexyl acrylate), acrylic acid ester co-polymers, methacrylic acid derivative polymers, methacrylic acid homopolymers, methacrylic acid ester homopolymers, poly(methyl methacrylate), poly(butyl methacrylate), poly(2-ethylhexyl methacrylate), acrylamido-methyl-propane sulfonate polymers, acrylamido-methyl-propane sulfonate derivative polymers, acrylamido-methyl-propane sulfonate co-polymers, acrylic acid/acrylamido-methyl-propane sulfonate co-polymers, benzyl coco di-(hydroxyethyl) quaternary amines, p-T-amyl-phenols condensed with formaldehyde, dialkyl amino alkyl (meth)acrylates, acrylamides, N-(dialkyl amino alkyl) acrylamide, methacrylamides, hydroxy alkyl (meth)acrylates, methacrylic acids, acrylic acids, hydroxyethyl acrylates, and the like, any derivative thereof, or any combination thereof.

Suitable lubricating agents for use in conjunction with the present invention may include, but not be limited to, ethoxylated fatty acids (e.g., the reaction product of ethylene oxide with pelargonic acid to form poly(ethylene glycol) (“PEG”) monopelargonate; the reaction product of ethylene oxide with coconut fatty acids to form PEG monolaurate), and the like, or any combination thereof. The lubricant agents may also be selected from nonwater-soluble materials such as synthetic hydrocarbon oils, alkyl esters (e.g., tridecyl stearate which is the reaction product of tridecyl alcohol and stearic acid), polyol esters (e.g., trimethylol propane tripelargonate and pentaerythritol tetrapelargonate), and the like, or any combination thereof.

Suitable emulsifiers for use in conjunction with the present invention may include, but not be limited to, sorbitan monolaurate, e.g., SPAN® 20 (available from Uniqema, Wilmington, Del.), or poly(ethylene oxide) sorbitan monolaurate, e.g., TWEEN® 20 (available from Uniqema, Wilmington, Del.).

Suitable vitamins for use in conjunction with the present invention may include, but not be limited to, vitamin B compounds (including B1 compounds, B2 compounds, B3 compounds such as niacinamide, niacinnicotinic acid, tocopheryl nicotinate, C₁-C₁₈ nicotinic acid esters, and nicotinyl alcohol; B5 compounds, such as panthenol or “pro-B5”, pantothenic acid, pantothenyl; B6 compounds, such as pyroxidine, pyridoxal, pyridoxamine; carnitine, thiamine, riboflavin); vitamin A compounds, and all natural and/or synthetic analogs of Vitamin A, including retinoids, retinol, retinyl acetate, retinyl palmitate, retinoic acid, retinaldehyde, retinyl propionate, carotenoids (pro-vitamin A), and other compounds which possess the biological activity of Vitamin A; vitamin D compounds; vitamin K compounds; vitamin E compounds, or tocopherol, including tocopherol sorbate, tocopherol acetate, other esters of tocopherol and tocopheryl compounds; vitamin C compounds, including ascorbate, ascorbyl esters of fatty acids, and ascorbic acid derivatives, for example, ascorbyl phosphates such as magnesium ascorbyl phosphate and sodium ascorbyl phosphate, ascorbyl glucoside, and ascorbyl sorbate; and vitamin F compounds, such as saturated and/or unsaturated fatty acids; or any combination thereof.

Suitable antimicrobials for use in conjunction with the present invention may include, but not be limited to, anti-microbial metal ions, chlorhexidine, chlorhexidine salt, triclosan, polymoxin, tetracycline, amino glycoside (e.g., gentamicin), rifampicin, bacitracin, erythromycin, neomycin, chloramphenicol, miconazole, quinolone, penicillin, nonoxynol 9, fusidic acid, cephalosporin, mupirocin, metronidazolea secropin, protegrin, bacteriolcin, defensin, nitrofurazone, mafenide, acyclovir, vanocmycin, clindamycin, lincomycin, sulfonamide, norfloxacin, pefloxacin, nalidizic acid, oxalic acid, enoxacin acid, ciprofloxacin, polyhexamethylene biguanide (PHMB), PHMB derivatives (e.g., biodegradable biguanides like polyethylene hexaniethylene biguanide (PEHMB)), clilorhexidine gluconate, chlorohexidine hydrochloride, ethylenediaminetetraacetic acid (EDTA), EDTA derivatives (e.g., disodium EDTA or tetrasodium EDTA), and the like, and any combination thereof.

Antistatic agents (antistats) for use in conjunction with the present invention may comprise any suitable anionic, cationic, amphoteric or nonionic antistatic agent. Anionic antistatic agents may generally include, but not be limited to, alkali sulfates, alkali phosphates, phosphate esters of alcohols, phosphate esters of ethoxylated alcohols, or any combination thereof. Examples may include, but not be limited to, alkali neutralized phosphate ester (e.g., TRYFAC® 5559 or TRYFRAC® 5576, available from Henkel Corporation, Mauldin, S.C.). Cationic antistatic agents may generally include, but not be limited to, quaternary ammonium salts and imidazolines which possess a positive charge. Examples of nonionics include the poly(oxyalkylene) derivatives, e.g., ethoxylated fatty acids like EMEREST® 2650 (an ethoxylated fatty acid, available from Henkel Corporation, Mauldin, S.C.), ethoxylated fatty alcohols like TRYCOL® 5964 (an ethoxylated lauryl alcohol, available from Henkel Corporation, Mauldin, S.C.), ethoxylated fatty amines like TRYMEEN® 6606 (an ethoxylated tallow amine, available from Henkel Corporation, Mauldin, S.C.), alkanolamides like EMID® 6545 (an oleic diethanolamine, available from Henkel Corporation, Mauldin, S.C.), or any combination thereof. Anionic and cationic materials tend to be more effective antistats.

In some embodiments, bulked webs may include a plurality of entangled polymer melt filaments being at least two types of polymer melt filaments.

In some embodiments, bulked webs may include a plurality of entangled polymer melt filaments such that the bulked webs have a heterogeneous cross-sectional make-up.

In some embodiments, bulked webs may include a plurality of entangled polymer melt filaments such that the bulked webs have a layered cross-sectional make-up.

In some embodiments, bulked webs may include a plurality of entangled polymer melt filaments such that the bulked webs have a bulk density of about 0.05 g/cm3 or less.

In some embodiments, bulked webs may include a plurality of entangled polymer melt filaments such that the bulked webs have a caliper of about 2 mm or greater.

In some embodiments, a nonwoven material may include a needleloomed bulked web comprising a plurality of entangled polymer melt filaments such that the nonwoven material has a caliper of about 2 mm or greater.

In some embodiments, a nonwoven material may include a hydroentangled bulked web comprising a plurality of entangled polymer melt filaments such that the nonwoven material has a caliper of about 2 mm or greater.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

The invention claimed is:

1. A system comprising:
at least one extruder having a plurality of nozzles; and
a master air jet in communication with at least one extruder to receive a plurality of polymer melt filaments from at least one extruder to form a bulked web.

2. The system of claim 1 further comprising:
a heating element in thermal communication with the plurality of filaments, the heating element disposed between the extruder and the master air jet.

3. The system of claim 1 further comprising:
an attenuator disposed between the extruder and the master air jet.

4. The system of claim 1 further comprising:
a filament collector screen disposed between the extruder and the master air jet.

5. The system of claim 4, wherein the filament collector screen and at least one die have a voltage applied thereacross.

6. The system of claim 1 further comprising:
a collector disposed after the master air jet.

7. The system of claim 1, wherein a first extruder is capable of producing a first type of polymer melt filament and a second extruder is capable of producing a second type of polymer melt filament.

8. The system of claim 1, wherein the master air jet is capable of also accepting at least one selected from the group consisting of: a plurality of preformed filament, a plurality of non-polymer melt filaments, a bulked web, a preformed bulked web, and any combination thereof.

9. The system of claim 1 further comprising:
a nonwoven manufacturing line capable in communication with the master air jet to receive the bulked web.

10. A system comprising:
at least two extruders having a plurality of nozzles;
an attenuator in communication with a first extruder to receive a first plurality of polymer melt filaments from the first extruder to form a plurality of attenuated filaments; and
a master air jet in communication with a second extruder and the attenuator to receive a second plurality of filaments from the second extruder and the plurality of attenuated filaments to form a bulked web.

11. The system of claim 10 further comprising:
a filament collector screen disposed between the second extruder and the master air jet.

12. The system of claim 11, wherein the filament collector screen and at least one die of the second extruder have a voltage applied thereacross.

13. The system of claim 10, wherein the master air jet is capable of also accepting at least one selected from the group consisting of: a plurality of preformed filaments, a plurality of non-polymer melt filaments, a bulked web, a preformed bulked web, and any combination thereof.

14. The system of claim 10 further comprising:
a nonwoven manufacturing line capable in communication with the master air jet to receive the bulked web.

15. A method comprising:
forming a plurality of polymer melt filaments;
passing the plurality of polymer melt filaments through a master air jet thereby forming a bulked web; and
collecting the bulked web.

16. The method of claim 15 further comprising:
heating the plurality of polymer melt filaments with a heating element.

17. The method of claim 15 further comprising:
introducing at least one selected from the group consisting of: a plurality of preformed filaments, a plurality of non-polymer melt filaments, a bulked web, a preformed bulked web, and any combination thereof into the master air jet with the plurality of polymer melt filaments.

18. The method of claim 15, wherein the bulked web has a cross-sectional make-up with a layered configuration, side-by-side configuration, or any combination thereof.

19. The method of claim 15, wherein the bulked web has a bulk density of about 0.05 g/cm³ or less.

20. The method of claim 15, wherein the bulked web has a caliper of about 2 mm or greater.

21. The method of claim 15 further comprising:
forming a nonwoven material from the bulked web.

22. The method of claim 21, wherein the nonwoven material has a bulk density of about 0.25 g/cm³ or less.

23. The method of claim 21, wherein the nonwoven material has a caliper of about 0.5 mm or greater.

24. The method of claim 21, wherein the nonwoven material comprises at least one additive that comprises at least one selected from the group consisting of an active particle, an active compound, an ion exchange resin, a zeolite, a nanoparticle, a ceramic particle, an abrasive particulate, an absorbent particulate, a softening agent, a plasticizer, a pigment, a dye, a flavorant, an aroma, a controlled-release vesicle, a binder, an adhesive, a tackifier, a surface modification agent, a lubricating agent, an emulsifier, a vitamin, a peroxide, a biocide, an antifungal, an antimicrobial, a deodorizer, an antistatic agent, a flame retardant, an antifoaming agent, a degradation agent, a conductivity modifying agent, a stabilizing agent, and any combination thereof.

25. The method of claim 15, wherein the polymer melt filaments comprise a thermoplastic polymer.

26. The method of claim 15, wherein the polymer melt filaments have a diameter ranging from about 10 microns to about 50 microns.

27. The method of claim 15, wherein the polymer melt filaments have a diameter ranging from about 0.25 micron to about 10 microns.

28. The method of claim 15, wherein forming involves applying a voltage across a die and a filament collector screen.

29. The method of claim 28, wherein polymer melt filaments have a diameter of about 10 microns or less.

30. The method of claim 15, wherein collecting involves conveying to another location.

31. A nonwoven material produced by the method of claim 21.

32. A method comprising:
forming a plurality of first polymer melt filaments;
forming a plurality of second polymer melt filaments; and
introducing the plurality of first polymer melt filaments and second polymer filaments into a master air jet thereby forming a bulked web.

33. The method of claim 32 further comprising:
forming a nonwoven material from the bulked web.

34. The method of claim 32 further comprising:
introducing at least one selected from the group consisting of: a plurality of preformed filaments, a plurality of non-polymer melt filaments, a bulked web, a preformed bulked web, and any combination thereof into the master air jet with the plurality of first polymer melt filaments and second polymer filaments.

35. A nonwoven material produced by the method of claim 33.

36. A method comprising:
forming a plurality of polymer melt filaments;
introducing the plurality of polymer melt filaments into a master air jet thereby producing a bulked web; and
forming a nonwoven material from the bulked web.

37. The method of claim 36, wherein the bulked web has a cross-sectional make-up with a layered configuration, side-by-side configuration, or any combination thereof.

38. The method of claim 36, wherein forming the nonwoven material involves at least one selected from the group consisting of: an additive application area, a calendaring area, a hydroentanglement area, a drying area, a heating area, a cooling area, a collection area, any hybrid thereof, and any combination thereof.

39. A bulked web comprising:
a plurality of entangled polymer melt filaments.

40. The bulked web of claim 39, wherein the plurality of entangled polymer melt filaments comprise at least two types of polymer melt filaments.

41. The bulked web of claim 39, wherein the bulked web has a heterogeneous cross-sectional make-up.

42. The bulked web of claim 39, wherein the bulked web has a layered cross-sectional make-up.

43. The bulked web of claim 39, wherein the bulked web has a bulk density of about 0.05 g/cm³ or less.

44. The bulked web of claim 39, wherein the bulked web has a caliper of about 2 mm or greater.

45. A nonwoven material comprising:
a needleloomed bulked web comprising a plurality of entangled polymer melt filaments, wherein the nonwoven material has a caliper of about 2 mm or greater.

46. A nonwoven product comprising the nonwoven material of claim 45.

47. A nonwoven material comprising:
a hydroentangled bulked web comprising a plurality of entangled polymer melt filaments, wherein the nonwoven material has a caliper of about 2 mm or greater.

48. A nonwoven product comprising the nonwoven material of claim 47.
